(19) United States
(12) Patent Application Publication
(10) Pub. No.: US 2007/0216916 A1
(43) Pub. Date: Sep. 20, 2007

(54) IMAGE PROCESSING SYSTEM CAPABLE OF RECOVERING DETAILS OF IMAGES AND RELATED IMAGE PROCESSING METHOD THEREOF

(76) Inventors: Bing-Jhe Chen, Miao- Li Hsien (TW); Po-Wei Chao, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/683,435

(22) Filed: Mar. 8, 2007

(30) Foreign Application Priority Data
Mar. 20, 2006 (TW) 095109472

(51) Int. Cl. G06F 15/00

(52) U.S. Cl. 358/1.9

(57) ABSTRACT

An image processing system includes: a motion detector, for determining whether a decoded pixel data corresponds to a still image; an encoder, for encoding the decoded pixel data when the decoded pixel data corresponds to a still image to generate an encoded pixel data; and a decoder, coupled to the encoder, for receiving the encoded pixel data and decoding the encoded pixel data to generate an decoded image data.

### BACKGROUND OF THE INVENTION

1. Field of the Invention

The invention relates to an image processing system and an image processing method, and more particularly, to an image processing system and an image processing method capable of recovering image details.

2. Description of the Prior Art

In a TV system (e.g., an NTSC specification), luminance and chrominance information are carried for transmission by a composite signal. In general, in an NTSC system, the high-frequency component of the composite signal carries both the high-frequency luminance information and the chrominance information, and the low-frequency component of the composite signal carries only the low-frequency luminance information.

Before an image is displayed, the chrominance information and luminance information should be separated. The separation process is called Y/C separation. However, since the chrominance information and the luminance information share the same channel, it is difficult to perfectly separate the chrominance information and the luminance information. Please note, if the chrominance information and the luminance information are not separated perfectly, a portion of high-frequency information may be regarded as chrominance information, which is called a cross-color distortion. On the other hand, the chrominance information may be misunderstood as being the luminance information, and this result is called cross-luminance distortion. Obviously, the image having cross-color distortion shows incorrect color in many pixels, and thus worsens display quality.

Generally speaking, because the front-end decoder may not perform the Y/C separation correctly or the data stored in the DVD may have already had cross-color distortion, the image data output from these front-end devices all may exhibit cross-color distortion. Therefore, in the prior art, in order to solve the problem of cross-color distortion, a circuit for suppressing the cross-color distortion is established in the back-end. However, although the above-mentioned back-end circuit can suppress the cross-color distortion, the display quality of the image data is still limited by the output of the front-end decoder (or disc data). In other words, the image data outputted from the front-end decoder may have already had distortions introduced. Even if or when the cross-color distortions can be suppressed, the details of the cross-color pixels in the image data itself cannot be recovered.

For example, the front-end decoder may be a 2D comb filter. As is well known by those having average skill in the art, the 2D comb filter cannot correctly perform the Y/C separation. Even in the back-end circuit, two successive fields are utilized to recover the pixel data, the recovered luminance information and the chrominance information are not the original luminance information and chrominance information carried by the composite signal. In fact, the recovered luminance information is a little less than the original luminance information, and which makes the details of the image data not clear. Obviously, the display quality still needs to be further improved.

### SUMMARY OF THE INVENTION

It is therefore one of the objectives of the claimed invention to provide an image processing system and related image processing method capable of recovering details of the image data. Therefore, the cross-color distortion can be suppressed and also the image details where the cross-color distortion takes place can be recovered. The display quality is improved and the above-mentioned problem can be solved.

According to an exemplary embodiment of the claimed invention, an image processing system is disclosed. The image processing system comprises: a motion detector, for determining whether a pixel data corresponds to a still image; an encoder, coupled to the motion detector, for encoding the pixel data to generate an encoded data if the pixel data corresponds to a still image; and a decoder, coupled to the encoder, for receiving the encoded data and decoding the encoded data to generate a decoded data.

According to another exemplary embodiment of the claimed invention, an image processing method is disclosed. The image processing method comprises: determining whether pixel data corresponds to a still image; if the pixel data corresponds to a still image, encoding the pixel data to generate encoded data; and decoding the encoded data to generate decoded data.

According to another exemplary embodiment of the claimed invention, an image processing system is disclosed. The image processing system comprises: an encoder, for encoding pixel data to generate encoded data; a motion detector, coupled to the encoder, for determining whether the encoded data corresponds to a still image; and a decoder, coupled to the motion detector, for receiving the encoded data, for decoding the encoded data if the encoded data corresponds to a still image.

According to another exemplary embodiment of the claimed invention, an image processing method is disclosed. The image processing method comprises: encoding pixel data to generate an encoded data; determining whether the encoded data corresponds to a still image; and decoding the encoded data if the encoded data corresponds to a still image to generate decoded data.

These and other objectives of the claimed invention will no doubt become obvious to those of ordinary skill in the art after reading the following detailed description of the preferred embodiment that is illustrated in the various figures and drawings.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an image processing system according to the present invention.

FIG. 2 is a flow chart of the operation of the image processing system shown in FIG. 1.

### DETAILED DESCRIPTION

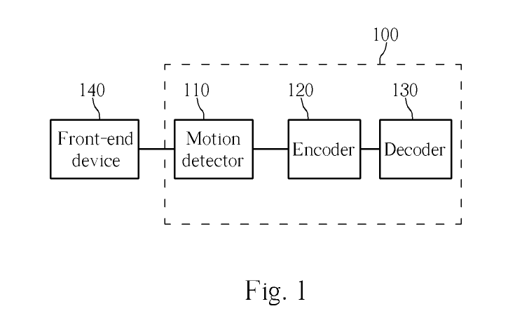

Please refer to FIG. 1, which is a diagram of an image processing system 100 according to the present invention. As shown in FIG. 1, the image processing system comprises a motion detector 110, an encoder 120, and a decoder 130. The motion detector 110 is coupled to the front-end device 140, such as the above-mentioned 2D comb filter or the DVD player, for receiving a decoded image signal, which has been decoded by the front-end device 140. The encoder 120 is coupled to the motion detector 120, and the decoder 130 is coupled to the decoder 120. The function and the operation of the above-mentioned devices will be illustrated in the following disclosure.

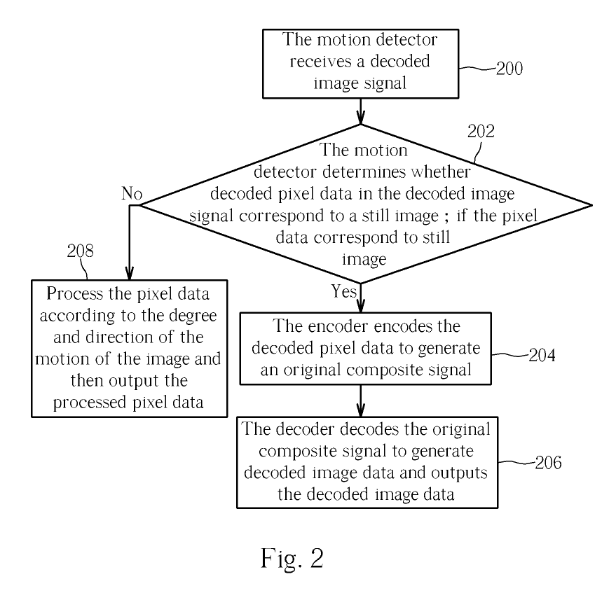

Please refer to FIG. 2, which is a flow chart of the operation of the image processing system 100 shown in FIG. 1. As shown in FIG. 2, the operation of the image processing system 100 includes following steps:

Step 200: The motion detector 110 receives a decoded image signal;

Step 202: The motion detector 110 determines whether decoded pixel data in the decoded image signal corresponds to a still image; if the pixel data corresponds to still image, go to step 204; otherwise, go to step 208;

Step 204: The encoder 120 encodes the decoded pixel data to generate an original composite signal;

Step 206: The decoder 130 decodes the original composite signal to generate decoded image data and outputs the decoded image data; and

Step 208: Process the pixel data according to the degree and direction of the motion of the image and then output the processed pixel data.

First, the motion detector 110 receives a decoded image signal (step 200) from the front-end device 140. For example, the decoded image signal may come from the front-end 2D comb filter or DVD player. As mentioned previously, the decoded image signal can be an image signal after Y/C separation, and the pixel data of the decoded image signal may have cross-color distortion.

After receiving the decoded image signal, the motion detector 110 performs motion detection on the decoded image signal to determine a part of the image, which corresponds to a still image (step 202). For example, the motion detector 110 determines whether each pixel data of the decoded image signal corresponds to a still image according to luminance information or chrominance information of corresponding pixel data of a plurality of fields/frames. If the detection result shows that the pixel data corresponds to a motion image, the pixel data is then processed according to the degree and direction of the motion of the image. For example, a temporal filter can be utilized in some motion images to raise the display quality, or some motion images are directly outputted to raise the display quality (step 208).

It should be noted that, the order of the above-mentioned step 202 and step 204 is only utilized as an embodiment, not a limitation to the scope of the present invention. In another embodiment, the order of the above-mentioned steps 202 and 204 can be reversed. In other words, the decoded pixel data can be encoded first, and then the motion detection is performed according to the encoded composite signal. This change also obeys the spirit of the present invention.

On the other hand, the fact that the pixel data corresponds to a still image indicates that the following cross-color suppression can be performed on the pixel data. Therefore, in this embodiment, the motion detector 110 outputs the pixel data corresponding to a still image to the encoder 120 (step 202). After receiving the pixel data outputted from the motion detector 110, the encoder 120 encodes the pixel data to recover each pixel data to an original pixel information (e.g., the composite signal before the Y/C separation performed by the front-end circuit 140) (step 204). And then, the composite signal is outputted to the decoder 130.

The decoder 130 decodes the composite signal to generate decoded image data (step 206) and then outputs the decoded image data for the temporal filtering operation. Please note that, not all pixel data corresponding to a still image need to be processed by the temporal filter. For example, the smooth area data does not need to be processed by the temporal filter. And then, the image data including the decoded image data after the execution of step 206 and after the temporal filtering and the image data after the execution of step 208 are transferred to the display device to display a complete field (i.e., frame).

As mentioned previously, it is certainly possible for the front-end circuit 140 to incorrectly decode the composite signal such that the decoded image data have cross-color distortion and blurred details. Therefore, in an embodiment of the present invention, the encoder 120 recovers the decoded image data to the initial condition, and the decoder 130 decodes the original composite signal in the following operations. The display quality of the present invention is no longer limited by the output of the front-end circuit 140 because of the encoding operation and decoding operation once more in the embodiment of the present invention. The Y/C information not only can be separated correctly, but also the problems described earlier whereby blurred details of the image are the unfortunate result are prevented. Furthermore, the present invention can suppress the cross-color distortion.

Please note, the above-mentioned decoder 130 is a 3D comb filter. The well-known 3D comb filter can successfully suppress the cross-color distortion. The function and operation of the 3D comb filter are also well-known, and thus omitted here for the sake of brevity.

In addition, the above-mentioned image processing system and related image processing method can be utilized in the NTSC system; however, it is not limited to be utilized in the NTSC system. For example, the present invention can also be utilized in a PAL system. Application of the present invention in the PAL system also obeys the spirit of the present invention.

Please note that, the present invention can be utilized in various image processing devices. For instance, the above-mentioned image processing system can be a modular device such that the image processing system can be widely utilized (e.g., embedded) inside various devices. For example, the image processing system can be embedded inside a TV controller to recover the image signal processed by the front-end decoder. The image processing system can also be embedded inside a DVD player to recover the disc data with cross-color distortion. As mentioned previously, the image processing system can be utilized in various image processing devices (e.g., video decoders, video encoders, LCD TVs, as well as others). This change also obeys the spirit of the present invention.

In contrast to the prior art, the present invention image processing system and related image processing method suppress the cross-color distortion, and also recover the details of the image so that the display quality can be significantly improved.

Those skilled in the art will readily observe that numerous modifications and alterations of the device may be made while retaining the teachings of the invention. Accordingly, the above disclosure should be construed as limited only by the metes and bounds of the appended claims.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing system, comprising:
a motion detector, for determining whether a pixel data corresponds to a still image;
an encoder, for encoding the pixel data to generate an encoded data if the pixel data corresponds to the still image; and
a decoder, for receiving the encoded data and decoding the encoded data to generate a decoded data.

2. The image processing system of claim 1, wherein an encoding operation executed by the encoder complies with NTSC specification.

3. The image processing system of claim 1, wherein an encoding operation executed by the encoder complies with PAL specification.

4. The image processing system of claim 1, wherein the encoded data is a composite signal.

5. The image processing system of claim 1, wherein the decoder is a 3D comb filter.

6. The image processing system of claim 1, wherein the image processing system is utilized in a TV controller, and the pixel data is read from a DVD.

7. The image processing system of claim 1, being utilized in a TV controller.

8. The image processing system of claim 1, being utilized in a video encoder.

9. The image processing system of claim 1, being utilized in a video decoder.

10. The image processing system of claim 1, wherein the pixel data corresponds to non-smooth area data.

11. The image processing system of claim 1, wherein the pixel data is an image signal after Y/C separation.

12. An image processing method, comprising:
determining whether a pixel data corresponds to a still image;
if the pixel data corresponds to the still image, encoding the pixel data to generate an encoded data; and
decoding the encoded data to generate a decoded data.

13. The image processing method of claim 12, wherein the operation of encoding the pixel data complies with NTSC specification.

14. The image processing method of claim 12, wherein the operation of encoding the pixel data complies with PAL specification.

15. The image processing method of claim 12, wherein the encoded data is a composite signal.

16. The image processing method of claim 12, wherein the image processing method is utilized in a DVD player, and the pixel data is read from a DVD.

17. The image processing method of claim 12, being utilized in a TV controller.

18. The image processing method of claim 12, wherein the pixel data corresponds to non-smooth area data.

19. An image processing system, comprising:
an encoder, for encoding a pixel data to generate an encoded data;
a motion detector, coupled to the encoder, for determining whether the encoded data correspond to a still image; and
a decoder, coupled to the motion detector, for receiving the encoded data and decoding the encoded data if the encoded data corresponds to the still image.

20. The image processing system of claim 19, wherein the encoded data is a composite signal.

21. The image processing system of claim 19, wherein the decoder is a 3D comb filter.

22. The image processing system of claim 19, wherein the pixel data corresponds to non-smooth area data.

23. An image processing method, comprising:
encoding pixel data to generate encoded data;
determining whether the encoded data corresponds to a still image; and
decoding the encoded data if the encoded data corresponds to a still image to generate decoded data.

24. The image processing method of claim 23, wherein the encoded image data is a composite signal.

25. The image processing method of claim 23, wherein the decoded pixel data correspond to non-smooth area data.
